(19) United States
(12) Patent Application Publication
(10) Pub. No.: US 2013/0202962 A1
(43) Pub. Date: Aug. 8, 2013

(54) CONDUCTIVE POLYMER/POROUS CARBON MATERIAL COMPOSITE AND ELECTRODE MATERIAL USING SAME

(71) Applicants: Tomoyuki Sakai, Kanagawa (JP); Tsukasa Maruyama, Kanagawa (JP)

(72) Inventors: Tomoyuki Sakai, Kanagawa (JP); Tsukasa Maruyama, Kanagawa (JP)

(73) Assignee: THE YOKOHAMA RUBBER CO., LTD., MINATO-KU, TOKYO (JP)

(21) Appl. No.: 13/878,796

(22) PCT Filed: Oct. 12, 2011
(86) PCT No.: PCT/JP2011/073374

§ 371 Date: Apr. 11, 2013

(30) Foreign Application Priority Data
Oct. 15, 2010 (JP) 2010-232672
Dec. 27, 2010 (JP) 2010-289422

(51) Int. Cl. H01G 9/042; H01G 11/48; H01M 4/133; H01M 4/60

(52) U.S. Cl. CPC H01G 9/042; H01M 4/606; H01M 4/608; H01G 11/48; H01M 4/133
USPC 429/212; 521/50; 521/150; 428/219

(57) ABSTRACT

The present invention provides: an electric double-layer capacitor, a lithium ion secondary battery, and a lithium ion capacitor, each having high electrostatic capacitance and excellent cycle characteristics; an electrode material capable of providing the electric double-layer capacitor, the lithium ion secondary battery, and the lithium ion capacitor; and a composite used in the electrode material. The composite of a conductive polymer has a nitrogen atom and a porous carbon material. The conductive polymer is bound to a surface of the porous carbon material. A total pore volume of all of the pores having a diameter of 0.5 to 100.0 nm measured by a BJH method is from 0.3 to 3.0 cm³/g, and a proportion, measured by the BJH method, of the pore volume of the pores having a diameter of 2.0 nm or more and less than 20.0 nm is not less than 10% of the total pore volume.

### TECHNICAL FIELD

The present invention relates to a conductive polymer/porous carbon material composite, an electrode material using the same, as well as an electric double-layer capacitor, lithium ion secondary battery, and lithium ion capacitor.

### BACKGROUND OF THE INVENTION

Lithium ion secondary batteries and electric double-layer capacitors are known as electrical storage devices.

Generally, in comparison to the electric double-layer capacitor, the lithium ion secondary battery has higher energy density and is capable of operation over a longer time interval.

On the other hand, in comparison to the lithium ion secondary battery, the electric double-layer capacitor is capable of rapid electrical charging and discharging, and working life over repeated uses is longer.

Moreover, in recent years, a lithium ion capacitor has been developed as an electrical storage device that combines such respective advantages of the lithium ion secondary battery and the electric double-layer capacitor.

For example, for an electric double-layer capacitor, the applicant of the present application in Patent Document 1 provides “an electrode material for an electric double-layer capacitor using a polyaniline/carbon composite produced by forming a composite of polyaniline or a derivative thereof and a carbonaceous material selected from the group consisting of activated carbon, Ketjen black, acetylene black, and furnace black, where the polyaniline or a derivative thereof is dedoped by base treatment of conductive polyaniline or a derivative thereof dispersed in a non-polar organic solvent.” The applicant of the present application in Patent Document 2 provides “a polyaniline/porous carbon composite produced by forming a composite of porous carbon material and conductive polyaniline or a derivative thereof dispersed in a doped state in a nonpolar organic solvent.”

Moreover, for a lithium ion capacitor, the applicant of the present application in Patent Document 3 proposes “an electric double-layer capacitor including (i) a positive electrode, (ii) a negative electrode containing such active material as can reversibly absorb and release the lithium ion, and (iii) an electrolyte solution comprising an aprotic organic solvent containing a lithium salt supporting electrolyte. In such an electric double-layer capacitor, the positive electrode contains a collector and electrode active material, using a conductive polyaniline/porous carbon composite produced by forming a composite of a conductive polyaniline or a derivative thereof dispersed in a doped state in a nonpolar organic solvent and porous carbon material as active material, as well as an electric conduction auxiliary agent and a binding agent as may be required.”

### PRIOR ART DOCUMENTS

### Patent Documents

Patent Document 1: Japanese Patent No. 4294067
Patent Document 2: Japanese Unexamined Patent Application Publication No. 2008-72079A
Patent Document 3: Japanese Unexamined Patent Application Publication No. 2008-300639A

### SUMMARY OF THE INVENTION

### Problem to be Solved by the Invention

As a result of investigation of the electrode materials and polyaniline/porous carbon composites described in Patent Documents 1 to 3, the inventors of the present invention found that specific surface area of the polyaniline/carbon composite was reduced and the pore distribution was changed due to factors such as the polyaniline molecular weight, concentration of the polyaniline dispersion used for preparation of the composite, presence or absence of dedoping, the dedoping procedure, and combination thereof or the like. The inventors of the present invention found that such the reduction and the change causes variance in the electrostatic capacitance and cycle characteristics.

Thus, the objects of the present invention are to provide an electric double-layer capacitor, lithium ion secondary battery, and lithium ion capacitor (referred to hereinafter collectively as the “electric double-layer capacitor or the like”) having high electrostatic capacitance and excellent cycle characteristics. Further objects of the present invention are to provide an electrode material capable of obtaining the electric double-layer capacitor or the like and to provide a composite used for this electrode material.

### Means to Solve the Problem

As a result of dedicated investigations, the inventors of the present invention achieved the present invention by discovery of the ability to obtain an electric double-layer capacitor or the like having high electrostatic capacitance and excellent cycle characteristics by use as an electrode material of porous carbon material having a certain conductive polymer bound to a surface of the porous carbon material, where the porous carbon material has a specific proportion of the pore volume of the pores having a certain diameter. Specifically, the present invention provides the following (1) to (9).

(1) A composite of a porous carbon material and a conductive polymer having nitrogen atoms; wherein

the conductive polymer is bound to a surface of the porous carbon material;

a total pore volume of all of the pores having a diameter of 0.5 to 100.0 nm measured by a BJH method is from 0.3 to 3.0 cm³/g; and

a proportion, measured by the BJH method, of the pore volume of the pores having a diameter of greater than or equal to 2.0 nm and less than 20.0 nm is greater than or equal to 10% of the total pore volume.

(2) The composite according to the above (1); wherein a proportion, measured by the BJH method, of the pore volume of the pores having a diameter of greater than or equal to 0.5 nm and less than 2.0 nm is less than 70% of the total pore volume.

(3) The composite according to the above (1) or (2); wherein a total specific surface area is from 1,300 to 2,500 m²/g.

(4) The composite according to any one of the above (1) to (3); wherein the conductive polymer is at least one selected from the group consisting of polyaniline, polypyrrole, polypyridine, polyquinoline, polythiazole, polyquinoxaline, and derivatives thereof.

(5) The composite according to any one of the above (1) to (4); wherein the porous carbon material is activated carbon and/or graphite.

(6) An electrode material including the composite described in any one of the above (1) to (5).

(7) An electric double-layer capacitor including a polarizable electrode using the electrode material described in the above (6).

(8) A lithium ion secondary battery having a negative electrode including the electrode material described in the above (6).

(9) A lithium ion capacitor having a positive electrode and/or a negative electrode including the electrode material described in the above (6).

### Effect of the Invention

As described below, the present invention is capable of providing an electric double-layer capacitor or the like that has high electrostatic capacitance and excellent cycle characteristics, an electrode material capable of obtaining the electric double-layer capacitor or the like, and a composite used for this electrode material.

Since electrostatic capacitance of the negative electrode material is normally extremely high in comparison to that of the positive electrode material in a lithium ion capacitor, the electrode material of the present invention, which is capable of improving electrostatic capacitance of the positive electrode material, is extremely useful due to the ability to increase capacitance of the overall device and also to decrease mass of the positive electrode material.

### BEST MODE FOR CARRYING OUT THE INVENTION

### [Composite]

The composite of the present invention is a composite of a nitrogen atom-containing conductive polymer and a porous carbon material. The conductive polymer is bound to a surface of the porous carbon material. A total pore volume of all of the pores having a diameter of 0.5 to 100.0 nm measured by a BJH method is from 0.3 to 3.0 cm³/g, and a proportion, measured by the BJH method, of the pore volume of the pores (sometimes referred to hereinafter as the “pore volume proportion”) having a diameter of greater than or equal to 2.0 nm and less than 20.0 nm (sometimes referred to hereinafter as the “certain diameter pores”) is greater than or equal to 10% of the total pore volume.

Here, the expression “a conductive polymer is bound to a surface of the porous carbon material” means that chemical bonds are formed by reaction (acid-base reaction) between the nitrogen atom of the conductive polymer (an amino group or imino group) and acidic functional groups of the surface of the porous carbon material, as exemplified by the hydroxyl group, carboxyl group, or the like.

Moreover, the expression “BJH method” means a method of determination of distribution of pore volume versus cylindrical pore diameters according to the standard Barrett-Joyner-Halenda model (J. Amer. Chem. Soc., 1951, vol. 73, pp. 373 to 377).

The expression “all of the pores” is taken to mean all of the pores having diameters of 0.5 to 100.0 nm, and the expression “total pore volume” is taken to mean the total value of pore volumes of all of the pores.

In the present invention, the aforementioned conductive polymer is bonded to the surface of the aforementioned porous carbon material and the total pore volume and the pore volume proportion of certain diameter pores satisfy the aforementioned ranges. Thus, the composite (electrode material) is capable of obtaining an electric double-layer capacitor or the like that has high electrostatic capacitance and excellent cycle characteristics.

This ability is thought to be due to the certain diameter pores being a size capable of diffusion of solvated ions without three-dimensional impediment, due to the pores being useful as regions capable of absorption, and due to the ability to suppress deterioration originating at free acidic functional groups present on the surface of the porous carbon material.

In the present invention, in order to increase electrostatic capacitance of the electric double-layer capacitor or the like, the pore volume proportion of the certain diameter pores is preferably greater than or equal to 15% of the total pore volume. From the standpoint of maintaining electrostatic capacitance per unit volume, the pore volume proportion of the certain diameter pores is preferably less than or equal to 30% of the total pore volume.

Furthermore, according to the present invention, in order to further increase electrostatic capacitance of the electric double-layer capacitor or the like, the proportion, measured by the BJH method, of the pore volume of the pores having a diameter of greater than or equal to 0.5 nm and less than 2.0 nm is preferably less than 70% of the total pore volume, and further preferably is less than 60% of the total pore volume.

For excellent balance between electrostatic capacitance per unit mass and electrostatic capacitance per unit volume, the composite of the present invention has a total specific surface area that is preferably from 1,300 to 2,500 m²/g, and further preferably is from 1,500 to 2,400 m²/g.

Here, “specific surface area” refers to a measurement taken using a nitrogen adsorption BET method in accordance with the method stipulated in JIS K1477.

The conductive polymer and the porous carbon material used for production of the composite of the present invention, the method of production of the composite of the present invention utilizing such, and the like will be described in detail.

### <Conductive Polymer>

No particular limitation is placed on the conductive polymer used for production of the composite of the present invention as long as the conductive polymer has nitrogen atoms and displays electrical conductivity by introduction of a dopant. The polymer may be doped by a dopant or may be a polymer obtained by dedoping of such a polymer, as exemplified by a P-type or an N-type conductive polymer having a conductivity of greater than or equal to 10⁻⁹Scm⁻¹.

Specific examples of such P-type conductive polymers include polyaniline, polypyrrole, and derivatives of such. One of these may be used alone, or two or more may be used in combination.

Specific examples of such N-type conductive polymers include polypyridine, polyquinoline, polythiazole, polyquinoxaline, and derivatives of such. One of these may be used alone, or two or more may be used in combination.

Among such conductive polymers, polyaniline, polypyridine, and derivatives thereof are preferred due to low cost of the raw materials and ease of synthesis.

Here, the derivative of polyaniline is exemplified by polymers obtained by polymerization of an aniline derivative (monomer) substituted at a non-4th position of aniline with at least one substituent such as an alkyl group, alkenyl group, alkoxy group, alkylthio group, aryl group, aryloxy group, alkylaryl group, arylalkyl group, or alkoxyalkyl group.

Similarly, the derivative of polypyridine is exemplified by polymers obtained by polymerization of a pyridine derivative (monomer) substituted at the 3th position, 4th position, and 6th position with at least one substituent such as an alkyl group, alkenyl group, alkoxy group, alkylthio group, aryl group, aryloxy group, alkylaryl group, arylalkyl group, and alkoxyalkyl group.

The polyaniline, polypyrrole, or derivative thereof of the present invention (referred to collectively hereinafter as “polyaniline or the like”) may be produced as a dispersion of the polyaniline or the like by chemical polymerization of the corresponding monomer (aniline, pyrrole, or derivative thereof; referred to collectively hereinafter as “aniline or the like”) in a nonpolar solvent.

Moreover, the dispersion of polyaniline or the like may be prepared, for example, by oxidative polymerization of aniline or the like in a nonpolar solvent containing added dopant. However, from the standpoint of the aforementioned range of pore volume proportion of certain diameter pores in the obtained composite of the present invention, it is important to adjust the concentration and the weight average molecular weight of the polyaniline or the like in the doped state in the aforementioned dispersion.

Concentration of doped state polyaniline or the like in the aforementioned dispersion is preferably from 0.1 to 3 mass %, further preferably is from 0.1 to 1.0 mass %, and most preferably is from 0.1 to 0.5 mass %. When concentration is in this range, effects of high electrostatic capacitance of the polyaniline or the like may be obtained without blockage of the pores of the below-described porous carbon material.

The weight average molecular weight of the doped state polyaniline or the like in the aforementioned dispersion is preferably from 400 to 20,000, further preferably is from 1,000 to 15,000, and most preferably is from 2,000 to 12,000.

Adjustment of the weight average molecular weight of the doped state polyaniline or the like in the aforementioned dispersion may be performed according to the amount of a molecular weight adjustment agent (i.e. terminal sealing agent). Specifically, in the polymerization of the polyaniline or the like, the added amount of the molecular weight adjustment agent (i.e. terminal sealing agent) is preferably from 0.1 to 1 equivalents relative to the aniline or the like. When the added amount of the molecular weight adjustment agent is within this range, it is possible to obtain effects of high electrostatic capacitance of the polyaniline or the like without blockage of pores of the below-described porous carbon material.

Note that, in the present invention, the weight average molecular weight of the doped state polyaniline or the like in the aforementioned dispersion may be found in the same manner as weight average molecular weight of de-doped state polyaniline or the like. Thus, after dedoping by base treatment or the like and recovery of the polyaniline or the like as a precipitate, weight average molecular weight is measured using gel permeation chromatography (GPC).

On the other hand, the polypyridine, polyquinoline, polythiazole, polyquinoxaline, or derivative thereof (referred to hereinafter collectively as the “polypyridine or the like”) may be produced as a dispersion of polypyridine or the like by dehalogenation polycondensation of the corresponding monomer in an aprotic or nonpolar solvent.

Cited example methods for preparation of the dispersion of the polypyridine or the like include: a method of preparation by dissolving and dispersing the polypyridine or the like in an organic acid such as formic acid or the like; a method of preparation by mixing a solution of the polypyridine or the like dissolved in an organic acid such as formic acid or the like and a solution of a dissolved polymer having an acidic group (e.g. polystyrene sulfonate or the like); a method of preparation by dissolving and dispersing the polypyridine or the like in an organic acid (e.g. formic acid or the like) containing a dissolved polymer having acidic groups (e.g. polystyrene sulfonate or the like); or the like.

The concentration of the polypyridine or the like in the dispersion and the utilized amount of molecular weight adjustment agent during polymerization are about the same as those used for the polymerization of polyaniline or the like.

In the present invention, the utilized amount of the aforementioned conductive polymer is preferably from 1 to 300 parts by mass per 100 parts by mass of the below-described porous carbon material.

Any of the aforementioned dopants or oxidation agents, molecular weight adjustment agents, phase transfer catalysts, or the like for chemical polymerization (oxidative polymerization) described in Patent Document 1 may be used as such components for the present invention.

### <Porous Carbon Material>

Although no particular limitation is placed on the specific surface area of the porous carbon material used in the production of the composite of the present invention, from the standpoint of making the total pore volume of the composite of the present invention from 0.3 to 3.0 cm³/g, a carbon material is preferred that has a specific surface area of 1,500 to 3,000 m²/g.

Specific examples of the aforementioned porous carbon material include activated carbon, graphite, boron-containing porous carbon material, nitrogen-containing porous carbon material, or the like. One of these may be used alone, or two or more may be used in combination.

Of these, the activated carbon and/or graphite is preferable because it is readily acquirable.

The activated carbon is not particularly limited, and conventional activated carbon particles that are used in carbon electrodes and the like can be used. Specific examples include activated carbon particles formed by activating coconut shell, wood dust, petroleum pitch, phenolic resins, and the like using water vapor, various chemicals, alkali, and the like. One of these may be used alone, or two or more may be used in combination.

Moreover, no particular limitation is placed on the graphite, and any known graphite may be utilized that is used as the lithium ion secondary battery negative electrode active material or the like. Specific examples of such graphite include natural graphite, artificial graphite, graphitized meso-carbon micro beads, graphitized mesophase pitch carbon fibers, or the like. One of these may be used alone, or two or more may be used in combination.

### <Method of Production of the Composite>

The below-described method may be cited as an example method for the production of the composite of the present invention using the aforementioned conductive polymer and porous carbon material.

Specifically, after the aforementioned conductive polymer and porous carbon material are mixed together, the dopant may be removed by dedoping to form the composite of the conductive polymer and porous carbon material.

No particular limitation is placed on the method of mixing the conductive polymer and porous carbon material. Specific examples of methods of mixing the conductive polymer and porous carbon material include: a method of mixing together the entire amount of porous carbon material with a dispersion of the conductive polymer; a method of preparing a pre-composite by mixing a dispersion of the conductive polymer with part of the porous carbon material, and thereafter mixing the pre-composite with the remaining porous carbon material; or the like.

Preferred methods for dedoping include: a method of dedoping the doped conductive polymer, and performing base treatment capable of neutralizing the dopant; a method of heat treatment of the dopant at a temperature that does not destroy the conductive polymer; or the like.

Among such preferred methods of dedoping, dedoping by heat treatment is preferred due to non-use of chemical reagents and organic solvents, completion of treatment in a short time interval due to the lack of need for a base reaction, and lack of salt residue and lack of the need for a washing step to wash out the salt after reaction. Dedoping by heat treatment is excellent for industrial application due to such reasons.

Specific examples of the aforementioned base treatment include: a method using a basic substance to treat the composite or a dispersion (mixed dispersion) obtained by mixing the conductive polymer and the porous carbon material; a method of mixing the aforementioned mixed dispersion or the aforementioned composite with water and/or organic solvent in which is dissolved the aforementioned basic substance; a method of causing contact between the aforementioned mixed dispersion or composite with a gas of the aforementioned basic substance; or the like.

The basic substance includes ammonia water, sodium hydroxide, potassium hydroxide, lithium hydroxide, magnesium hydroxide, calcium hydroxide and other metal hydroxides; methylamine, ethylamine, triethylamine and other amines; tetramethyl ammonium hydroxide, tetraethyl ammonium hydroxide, and other alkyl ammonium hydroxides; hydrazine, phenyl hydrazine and other hydrazine compounds; diethyl hydroxylamine, dibenzyl hydroxylamine and other hydroxylamine compounds, and the like.

Moreover, the aforementioned organic solvent may be any organic solvent that dissolves the aforementioned basic substance. Specific examples of the organic solvent include aromatic hydrocarbons such as toluene, xylene, or the like; aliphatic hydrocarbons such as hexane, heptane, cyclohexane, or the like; halogenated hydrocarbons such as chloroform, dichloromethane, or the like; esters such as ethyl acetate, butyl acetate, or the like; alcohols such as methanol, ethanol, or the like; sulfoxides such as dimethyl sulfoxide or the like; amides such as dimethylformamide or the like; carbonic acid esters such as propylene carbonate, dimethyl carbonate, diethyl carbonate, or the like; lactones such as -butyrolactone, -valerolactone, or the like; nitriles such as acetonitrile, propionitrile, or the like; N-methyl-2-pyrrolidone; or the like.

The heat treatment is performed at a temperature selected appropriately for decomposition and removal of the dopant alone without particularly harming the properties of the conductive polymer. For example, the heat treatment is preferably performed at least 20° C. below the decomposition temperature of the conductive polymer as measured by thermogravimetric analysis. Specifically, heat treatment is further preferably performed at a temperature of greater than or equal to 250° C. and less than 400° C.

The composite of the present invention is preferably formed by using the aforementioned base treatment for dedoping of the dopant in the aforementioned conductive polymer, although it is also permissible to use as the aforementioned conductive polymer a conductive polymer that has not been entirely de-doped.

The amount of dopant contained in the conductive polymer after base treatment, as indicated by mol ratio per monomer unit of the conductive polymer, is preferably from 0 to 0.3, and further preferably is from 0 to 0.1.

A conventional mixing apparatus may be used for preparation of the aforementioned mixture of the conductive polymer and the porous carbon material, as exemplified by mixing-dispersing equipment such as a sand mill, bead mill, ball mill, planetary ball mill, three-roll mill, colloid mill, ultrasonic homogenizer, Henschel mixer, jet mill, planetary mixer, or the like.

### [Electrode Material]

The electrode material of the present invention is an electrode material that utilizes as the active material the aforementioned composite of the present invention. Specifically, the electrode material of the present invention may be used as the material of the polarizable electrode of the below-descried electric double-layer capacitor of the present invention, as material of the negative electrode of a lithium ion secondary battery, and as the negative and/or positive electrode materials of a lithium ion capacitor.

### [Electric Double-Layer Capacitor]

The electric double-layer capacitor of the present invention is an electric double-layer capacitor that has a polarizable electrode formed using the aforementioned electrode material of the present invention.

### [Lithium Ion Secondary Battery]

The lithium ion secondary battery of the present invention is a lithium ion secondary battery that has a negative electrode formed using the aforementioned electrode material of the present invention.

### [Lithium Ion Capacitor]

The lithium ion capacitor of the present invention is a lithium ion capacitor that has a positive and/or a negative electrode formed using the aforementioned electrode material of the present invention.

The polarizable electrode, positive electrode, and negative electrode in the electric double-layer capacitor, lithium ion secondary battery, and lithium ion capacitor of the present invention (referred to hereinafter as the “electric double-layer capacitor or the like of the present invention”), for example, may be constituted by the composite of the present invention and a collector (e.g. platinum, copper, nickel, aluminum, or the like).

Although a binding agent or conductivity aid are not necessarily needed because the aforementioned polarizable electrode includes the aforementioned conductive polymer, a binding agent or conductivity aid may be used as may be required. If a binding agent or conductivity aid is used, the electrode material of the present invention may use the binding agent or conductivity aid together with the aforementioned conductive polymer and porous carbon material.

Specific examples of the aforementioned binding agent include polyvinylidene fluoride, polytetrafluoroethylene, fluoro-olefin copolymers, carboxymethyl cellulose, polyvinyl alcohol, polyacrylic acid, polyvinylpyrrolidone, polymethyl methacrylate, or the like.

Specific examples of the aforementioned conductivity aid include carbon black (particularly acetylene black and Ketjen black), natural graphite, thermal expandable graphite, carbon fibers, nano-carbon material, ruthenium oxide, metal fiber (e.g. aluminum, nickel, or the like), or the like.

In addition to the aforementioned electrode material (composite) of the present invention used as the aforementioned polarizable electrode, a conventional structure may be adopted for the electric double-layer capacitor or the like of the present invention (e.g. a negative electrode including as an active material graphite or the like capable of reversibly absorbing and discharging lithium ions, and an electrolyte solution comprised of an aprotic organic solvent including a lithium salt supporting electrolyte, or the like), and the electric double-layer capacitor or the like of the present invention may be manufactured by conventional known production methods.

### EXAMPLES

The present invention will now be described in greater detail using the following examples, but is in no way limited to these examples.

### <Preparation of Polyaniline Toluene Dispersion 1>

1.2 g of aniline, 2.6 g of dodecyl benzene sulfonic acid, and 0.26 g of 2,4,6-trimethylaniline (0.15 equivalent relative to the aniline) as a molecular weight adjustment agent (terminal sealing agent) were dissolved in 200 g of toluene. Thereafter, to this mixture was added 100 g of distilled water into which was dissolved 2.2 mL of 6N hydrochloric acid.

To the mixed solution, 0.36 g of tetrabutyl ammonium bromide was added, the mixture was cooled to 5° C. or less, then 80 g of distilled water, in which 3.52 g of ammonium persulfate was dissolved, was added.

The mixture was oxidatively polymerized in a state of 5° C. or less for 6 hours, then 100 g of toluene, then a methanol-water mixed solvent (water/methanol=2/3 (mass ratio)) were added thereto, and the resultant mixture was stirred.

After the end of stirring, the reaction solution was separated into the toluene layer and the aqueous layer, and only the aqueous layer was removed so as to obtain a polyaniline toluene dispersion 1.

A part of the polyaniline toluene dispersion 1 was taken and the toluene distilled off in vacuum, whereby it was found that the dispersion contained 1.2 mass % of a solid ingredient (a polyaniline content: 0.4 mass %). Further, this dispersion was filtered by a filter having a pore size of 1.0 μm, whereupon there was no clogging.

The particle size of the polyaniline particles in the dispersion was analyzed by an ultrasonic particle size distribution measurement apparatus (manufactured by Matec Applied Sciences, APS-100). As a result, it was learned that the particle size distribution was a mono-dispersion (i.e., the peak value 0.19 μm, the half width of 0.10 μm). Further, this dispersion did not agglomerate or precipitate even after the elapse of 1 year at room temperature, and thus was stable. From the elementary analysis, the molar ratio of the dodecyl benzene sulfonic acid per aniline monomer unit was 0.45. The yield of the polyaniline obtained was 95%.

### <Preparation of Polyaniline Toluene Dispersion 2>

Polyaniline toluene dispersion 2 was obtained by polymerization by the same method as that of the polyaniline toluene dispersion 1 except for use of 0.52 g of 2,4,6-trimethylaniline (0.30 equivalents relative to the aniline).

A part of the polyaniline toluene dispersion 2 was taken and the toluene distilled off in vacuum, whereby it was found that the dispersion contained 1.4 mass % of a solid ingredient (a polyaniline content: 0.4 mass %). Further, this dispersion was filtered by a filter having a pore size of 1.0 μm, whereupon there was no clogging.

The particle size of the polyaniline particles in the dispersion was analyzed by an ultrasonic particle size distribution measurement apparatus (manufactured by Matec Applied Sciences, APS-100). As a result, it was learned that the particle size distribution was a mono-dispersion (i.e., the peak value of 0.14 μm, the half width of 0.08 μm). Further, this dispersion did not agglomerate or precipitate even after the elapse of 1 year at room temperature, and thus was stable. From the elementary analysis, the molar ratio of the dodecyl benzene sulfonic acid per aniline monomer unit was 0.45. The yield of the polyaniline obtained was 93%.

### <Preparation of Polypyridine Aqueous Dispersion>

To 50 g of dry dimethyl formaldehyde were dissolved 5 g of 2,5-dibromopyridine, 0.5 g of 2-bromopyridine as a molecular weight adjustment agent (0.15 equivalents relative to the pyridine monomer), 9 g of bis(1,5-cyclooctadiene) nickel as a polycondensation agent. Thereafter, the polymerization reaction was performed for 16 h at 60° C. under nitrogen.

After completion of the reaction, polypyridine was purified by the below-described operation.

Firstly, the reaction solution was poured into 200 mL of 0.5 mol/L hydrochloric acid aqueous solution. After stirring for 2 h at room temperature, the precipitate was filtered out and recovered.

Thereafter, the recovered precipitate was stirred again in 200 mL of 0.5 mol/L hydrochloric acid aqueous solution for 8 h at room temperature, and the precipitate was filtered out and recovered.

Thereafter, the recovered precipitate was stirred in 200 mL of 0.1 mol/L ammonium aqueous solution for 3 h at room temperature to isolate and purify the polypyridine.

The obtained polypyridine powder was dried under vacuum. 1.72 g was recovered (92% yield).

A polypyridine formic acid solution was prepared beforehand by dissolving 0.8 g of polypyridine powder in 9.2 g of 88% formic acid. This polypyridine formic acid solution and 15 g of 18% polystyrene sulfonate aqueous solution were mixed and stirred. Thereafter, 175 g of distilled water was added to prepare a polypyridine aqueous dispersion (containing 0.4 mass % polypyridine).

The particle size of the polypyridine particles in the dispersion was analyzed by an ultrasonic particle size distribution measurement apparatus (manufactured by Matec Applied Sciences, APS-100). As a result, it was learned that the particle size distribution was a mono-dispersion (i.e., the peak value of 0.25 μm, the half width of 0.12 μm).

### <Preparation of Polyaniline Toluene Dispersion 3>

Polyaniline toluene dispersion 3 was prepared by the same method as that of Patent Document 1.

Specifically, into 150 g of toluene were dissolved 12.6 g of aniline, 26.4 g of dodecyl benzene sulfonic acid, and 0.63 g of 2,4,6-trimethylaniline as a molecular weight adjustment agent (terminal sealing agent). Thereafter, 100 g of distilled water was added into which had been dissolved 22.5 mL of 6N hydrochloric acid.

To the mixed solution, 3.8 g of tetrabutyl ammonium bromide was added, the mixture was cooled to 5° C. or less, then 80 g of distilled water, in which 33.9 g of ammonium persulfate was dissolved, was added.

The mixture was oxidatively polymerized in a state of 5° C. or less for 6 hours, then 100 g of toluene, then a methanol-water mixed solvent (water/methanol=2/3 (mass ratio)) were added thereto, and the resultant mixture was stirred.

After the end of stirring, the reaction solution was separated into the toluene layer and the aqueous layer, and only the aqueous layer was removed so as to obtain a polyaniline toluene dispersion 3.

A part of the polyaniline toluene dispersion 3 was taken and the toluene distilled off in vacuum, whereby it was found that the dispersion contained 12.9 mass % of a solid ingredient (a polyaniline content: 5 mass %). Further, this dispersion was filtered by a filter having a pore size of 1.0 μm, whereupon there was no clogging.

The particle size of the polyaniline particles in the dispersion was analyzed by an ultrasonic particle size distribution measurement apparatus (manufactured by Matec Applied Sciences, APS-100). As a result, it was learned that the particle size distribution was a mono-dispersion (i.e., the peak value of 0.33 μm, the half width of 0.17 μm). Further, this dispersion did not agglomerate or precipitate even after the elapse of 1 year at room temperature, and thus was stable. From the elementary analysis, the molar ratio of the dodecyl benzene sulfonic acid per aniline monomer unit was 0.45. The yield of the polyaniline obtained was 96%.

### <Preparation of Polyaniline Toluene Dispersion 4>

Polyaniline toluene dispersion 4 was prepared by the same method as that of Patent Document 3.

Specifically, into 150 g of toluene were firstly dissolved 3 g of aniline, 6.3 g of dodecyl benzene sulfonic acid, and 0.15 g of 2,4,6-trimethylaniline as a molecular weight adjustment agent (terminal sealing agent). Thereafter, 75 g of distilled water was added into which had been dissolved 5.36 mL of 6N hydrochloric acid.

To this mixed solvent was added 0.9 g of tetrabutyl ammonium bromide. After performing oxidative polymerization for 6 h at temperatures below or equal to 5° C., 100 g of toluene and then methanol/water mixed solvent (methanol:water=2:3 (weight ratio)) were added in turn, and the mixture was stirred.

After the end of stirring, the reaction solution was separated into the toluene layer and the aqueous layer, and only the aqueous layer was removed so as to obtain a polyaniline toluene dispersion 4.

A part of the polyaniline toluene dispersion 4 was taken and the toluene distilled off in vacuum, whereby it was found that the dispersion contained 3.1 weight % of a solid ingredient (a polyaniline content: 1.2 weight %). Further, this dispersion was filtered by a filter having a pore size of 1.0 μm, whereupon there was no clogging. Further, this dispersion did not agglomerate or precipitate even after the elapse of 1 year at room temperature, and thus was stable. From the elementary analysis, the molar ratio of the dodecyl benzene sulfonic acid per anion monomer unit was 0.45. The yield of the polyaniline obtained was 96%.

### <Preparation of Polypyrrole Dispersion>

To 150 g of toluene were dissolved 3 g of pyrrole, 12.0 g of dodecyl benzene sulfonic acid, and 0.15 g of 2-methylpyrrole as a molecular weight adjustment agent (terminal sealing agent). Thereafter, 75 g of distilled water was added into which had been dissolved 5.36 mL of 6N hydrochloric acid.

To this mixed solvent was added 0.9 g of tetrabutyl ammonium bromide. After performing oxidative polymerization for 6 h at temperatures below or equal to 0° C., 100 g of toluene and then methanol/water mixed solvent (methanol:water=2:3 (weight ratio)) were added in turn, and the mixture was stirred.

After the end of stirring, the reaction solution was separated into the toluene layer and the aqueous layer, and only the aqueous layer was removed so as to obtain a polypyrrole toluene dispersion.

A part of the polypyrrole toluene dispersion was taken and the toluene distilled off in vacuum, whereby it was found that the dispersion contained 4.1 mass % of a solid ingredient (a pyrrole content: 1.2 mass %). Further, this dispersion was filtered by a filter having a pore size of 1.0 μm, whereupon there was no clogging. Further, this dispersion did not agglomerate or precipitate even after the elapse of 1 year at room temperature, and thus was stable. From the elementary analysis, the molar ratio of the dodecyl benzene sulfonic acid per anion monomer unit was 0.95. The yield of the polypyrrole obtained was 94%.

### <Preparation of Composite 1>

To 2,500 g of the polyaniline toluene dispersion 1 (a polyaniline content: 0.4 mass %) was added 80 g of activated carbon (NK260, specific surface area=2,000 m²/g, acidic functional group content=0.1 mmol, produced by Kuraray Chemical Co., Ltd.) to obtain a mixed dispersion.

To the mixed dispersion, 50 mL of a 2 mole/liter triethylamine in methanol solution was added, then the mixture was stirred and mixed for 5 hours.

After the end of the stirring, the precipitate was recovered by filtration and washed with methanol. The filtrate and the washed solution at this time were colorless and transparent.

The washed and purified precipitate was dried under vacuum to prepare a polyaniline/activated carbon composite (referred to hereinafter as the “composite 1”).

A rapid specific surface area/pore distribution measurement instrument (model ASAP 2020, manufactured by Shimadzu Micrometitics) using the BJH method was used to measure total pore volume, pore volume of pores having diameters of greater than or equal to 2.0 nm and less than 20.0 nm, and pore volume of pores having diameters of greater than or equal to 0.5 nm and less than 2.0 nm of the obtained composite 1. The pore volume proportion for each pore volume was calculated based on these measurement values. These results are shown below in Table 1.

### <Preparation of Composite 2>

To 7,500 g of the polyaniline toluene dispersion 1 (a polyaniline content: 0.4 mass %) was added 60 g of activated carbon 1 (NK260, specific surface area=2,000 m²/g, acidic functional group content=0.1 mmol, produced by Kuraray Chemical Co., Ltd.) to obtain a mixed dispersion.

To the mixed dispersion, 50 mL of a 2 mole/liter triethylamine in methanol solution was added, then the mixture was stirred and mixed for 5 hours.

After the end of the stirring, the precipitate was recovered by filtration and washed with methanol. The filtrate and the washed solution at this time were colorless and transparent.

The washed and purified precipitate was dried under vacuum to prepare a polyaniline/activated carbon composite (referred to hereinafter as the “composite 2”).

The same method as that of composite 1 was used to measure total pore volume, pore volume of pores having diameters of greater than or equal to 2.0 nm and less than 20.0 nm, and pore volume of pores having diameters of greater than or equal to 0.5 nm and less than 2.0 nm of the obtained composite 2. The pore volume proportion for each pore volume was calculated based on these measurement values. These results are shown below in Table 1.

### <Preparation of Composite 3>

A polyaniline/activated carbon composite (referred to hereinafter as the “composite 3”) was prepared by the same method as that of composite 2 except for use of the polyaniline toluene dispersion 2 (a polyaniline content: 0.4 mass %) rather than the polyaniline toluene dispersion 1.

The same method as that of composite 1 was used to measure total pore volume, pore volume of pores having diameters of greater than or equal to 2.0 nm and less than 20.0 nm, and pore volume of pores having diameters of greater than or equal to 0.5 nm and less than 2.0 nm of the obtained composite 3. The pore volume proportion for each pore volume was calculated based on these measurement values. These results are shown below in Table 1.

### <Preparation of Composite 4>

A polypyridine/activated carbon composite (referred to hereinafter as the “composite 4”) was prepared by the same method as that of composite 2 except for use of the polypyridine aqueous dispersion (a polypyridine content: 0.4 mass %) rather than the polyaniline toluene dispersion 1.

The same method as that of composite 1 was used to measure total pore volume, pore volume of pores having diameters of greater than or equal to 2.0 nm and less than 20.0 nm, and pore volume of pores having diameters of greater than or equal to 0.5 nm and less than 2.0 nm of the obtained composite 4. The pore volume proportion for each pore volume was calculated based on these measurement values. These results are shown below in Table 1.

### <Preparation of Composite 5>

A mixed dispersion was obtained by addition of 60 g of activated carbon 1 (NK260, specific surface area=2,000 m²/g, acidic functional group amount=0.1 mmol, produced by Kuraray Chemical Co., Ltd.) to 7,500 g of the polyaniline toluene dispersion 1 (a polyaniline content: 0.4 mass %) in the same manner as for the composite 2.

Thereafter, this mixed dispersion was stirred for 1 h, and then the precipitate was recovered by filtration.

The recovered precipitate was left for 3 hours at 350° C. in a nitrogen atmosphere to remove dopant by decomposition and to prepare the polyaniline/activated carbon composite (referred to hereinafter as the “composite 5”).

The same method as that of composite 1 was used to measure total pore volume, pore volume of pores having diameters of greater than or equal to 2.0 nm and less than 20.0 nm, and pore volume of pores having diameters of greater than or equal to 0.5 nm and less than 2.0 nm of the obtained composite 5. The pore volume proportion for each pore volume was calculated based on these measurement values. These results are shown below in Table 1.

### <Preparation of Composite 6>

A polyaniline/activated carbon composite (referred to hereinafter as the “composite 6”) was prepared in the same manner as for the composite 5 except for use of 600 g of the polyaniline toluene dispersion 3 (a polyaniline content: 5 mass %) rather than the polyaniline toluene dispersion 1.

The same method as that of composite 1 was used to measure total pore volume, pore volume of pores having diameters of greater than or equal to 2.0 nm and less than 20.0 nm, and pore volume of pores having diameters of greater than or equal to 0.5 nm and less than 2.0 nm of the obtained composite 6. The pore volume proportion for each pore volume was calculated based on these measurement values. These results are shown below in Table 1.

### <Preparation of Composite 7>

A polyaniline/activated carbon composite (referred to hereinafter as the “composite 7”) was prepared in the same manner as for the composite 5 except for use of 2,500 g of the polyaniline toluene dispersion 4 (a polyaniline content: 1.2 mass %) rather than the polyaniline toluene dispersion 1, and addition of 80 g of activated carbon 1 (NK260, specific surface area=2,000 m²/g, acidic functional group amount=0.1 mmol, produced by Kuraray Chemical Co., Ltd.).

The same method as that of composite 1 was used to measure total pore volume, pore volume of pores having diameters of greater than or equal to 2.0 nm and less than 20.0 nm, and pore volume of pores having diameters of greater than or equal to 0.5 nm and less than 2.0 nm of the obtained composite 7. The pore volume proportion for each pore volume was calculated based on these measurement values. These results are shown below in Table 1.

### <Preparation of Composite 8>

A mixed dispersion was obtained in the same manner as for composite 1 by addition of 80 g of activated carbon 1 (NK260, specific surface area=2,000 m²/g, acidic functional group amount=0.1 mmol, produced by Kuraray Chemical Co., Ltd.) to 2,500 g of a polypyrrole toluene dispersion (a polypyrrole content: 1.2 mass %).

Thereafter, this mixed dispersion was stirred for 1 h, and then a precipitate was recovered by filtration.

The recovered precipitate was left for 3 hours at 350° C. in a nitrogen atmosphere to remove dopant by decomposition and to prepare the polypyrrole/activated carbon composite (referred to hereinafter as the “composite 8”).

The same method as that of composite 1 was used to measure total pore volume, pore volume of pores having diameters of greater than or equal to 2.0 nm and less than 20.0 nm, and pore volume of pores having diameters of greater than or equal to 0.5 nm and less than 2.0 nm of the obtained composite 8. The pore volume proportion for each pore volume was calculated based on these measurement values. These results are shown below in Table 1.

### <Activated Carbon>

Total pore volume, pore volume of pores having diameters of greater than or equal to 2.0 nm and less than 20.0 nm, and pore volume of pores having diameters of greater than or equal to 0.5 nm and less than 2.0 nm of the activated carbon 1 (NK260, specific surface area=2,000 m²/g, acidic functional group amount=0.1 mmol, produced by Kuraray Chemical Co., Ltd.) were measured by the same method as was used for the composite 1. The pore volume proportion for each pore volume was calculated based on these measurement values. These results are shown below in Table 1.

### <Preparation of Composite 9>

A polyaniline/activated carbon composite (referred to hereinafter as the “composite 9”) was prepared in the same manner as that of the composite 1 except for no treatment (i.e. dedoping by base treatment) by addition of 50 mL of a 2 mol/L triethylamine in methanol solution.

Although the same method as that of composite 1 was used to measure total pore volume, pore volume of pores having diameters of greater than or equal to 2.0 nm and less than 20.0 nm, and pore volume of pores having diameters of greater than or equal to 0.5 nm and less than 2.0 nm of the obtained composite 9, the value of the pore volume of pores having diameters of greater than or equal to 2.0 nm and less than 20.0 nm was too small so that measurement was impossible. Thus, total pore volume or the like in the below listed Table 1 is indicated by “-”.

### <Preparation of Composite 10>

A polyaniline NMP solution (a polyaniline content: 0.4 mass %) was prepared by dissolving 0.4 g of commercial product type polyaniline powder (produced by Sigma-Aldrich Co. LLC.) in 99.6 g of N-methyl-2-pyrrolidone (NMP).

A mixed dispersion was obtained by addition of 80 g of activated carbon 1 (NK260, specific surface area=2,000 m²/g, acidic functional group amount=0.1 mmol, produced by Kuraray Chemical Co., Ltd.) to 2,500 g of the polyaniline NMP solution.

Polyaniline/activated carbon composite (referred to hereinafter as the “composite 10”) was prepared by vacuum distillation by heating and removing the NMP from the mixed dispersion.

Although the same method as that of composite 1 was used to measure total pore volume, pore volume of pores having diameters of greater than or equal to 2.0 nm and less than 20.0 nm, and pore volume of pores having diameters of greater than or equal to 0.5 nm and less than 2.0 nm of the obtained composite 10, the value of the pore volume of pores having diameters of greater than or equal to 2.0 nm and less than 20.0 nm was too small so that measurement was impossible. Thus, total pore volume or the like in the below listed Table 1 is indicated by “-”.

### <Preparation of Composite 11>

A polyaniline/activated carbon composite (referred to hereinafter as the “composite 11”) was prepared by the same method as that used for the composite 2 except for use of the polyaniline toluene dispersion 3 (a polyaniline content: 5 mass %) rather than the polyaniline toluene dispersion 1.

The same method as that of composite 1 was used to measure total pore volume, pore volume of pores having diameters of greater than or equal to 2.0 nm and less than 20.0 nm, and pore volume of pores having diameters of greater than or equal to 0.5 nm and less than 2.0 nm of the obtained composite 11. The pore volume proportion for each pore volume was calculated based on these measurement values. These results are shown below in Table 1.

### <Preparation of Composite 12>

In the same manner as that of composite 7, a mixed dispersion was obtained by addition of 80 g of activated carbon 1 (NK260, specific surface area=2,000 m²/g, amount of acidic functional groups=0.1 mmol, produced by Kuraray Chemical Co., Ltd.) to 2,500 g of the polyaniline toluene dispersion 4 (a polyaniline content: 1.2 mass %).

Thereafter, this mixed dispersion was stirred for 1 h, and the precipitate was recovered by filtration.

The recovered precipitate was left for 10 hours at 120° C. in a nitrogen atmosphere to prepare the polyaniline/activated carbon composite (referred to hereinafter as the “composite 12”) without performing treatment to decompose and remove the dopant.

Although the same method as that of composite 1 was used to measure total pore volume, pore volume of pores having diameters of greater than or equal to 2.0 nm and less than 20.0 nm, and pore volume of pores having diameters of greater than or equal to 0.5 nm and less than 2.0 nm of the obtained composite 12, the value of the pore volume of pores having diameters of greater than or equal to 2.0 nm and less than 20.0 nm was too small so that measurement was impossible. Thus, total pore volume or the like in the below listed Table 1 is indicated by “-”.

TABLE 1

| | | Composite | | | | | |
|---|---|---|---|---|---|---|---|
| | Activated | | | | | | |
| | carbon 1 | 1 | 2 | 3 | 4 | 5 | 6 |
| Total specific | 2000 | 1710 | 1850 | 1420 | 1470 | 2400 | 1930 |
| surface area (m²/g) | | | | | | | |
| Total pore volume | 1.171 | 0.729 | 0.839 | 0.568 | 0.647 | 1.400 | 0.942 |
| (cm³/g) | | | | | | | |
| (diameter = 0.5 | | | | | | | |
| to 100 nm) | | | | | | | |
| Pore volume (cm³/g) | 0.082 | 0.124 | 0.151 | 0.108 | 0.097 | 0.182 | 0.113 |
| (diameter = at least | | | | | | | |
| 2.0 nm and | | | | | | | |
| less than 20.0 nm) | | | | | | | |
| Pore volume | 7 | 17 | 18 | 19 | 15 | 13 | 12 |
| proportion (%) | | | | | | | |
| (diameter = at least | | | | | | | |
| 2.0 nm and | | | | | | | |
| less than 20.0 nm) | | | | | | | |
| Pore volume (cm³/g) | 1.019 | 0.481 | 0.386 | 0.301 | 0.440 | 0.910 | 0.480 |
| (diameter = at least | | | | | | | |
| 0.5 nm and | | | | | | | |
| less than 2.0 nm) | | | | | | | |
| Pore volume proportion (%) | 87 | 66 | 46 | 53 | 68 | 65 | 51 |
| (diameter = at least | | | | | | | |
| 0.5 nm and | | | | | | | |
| less than 2.0 nm) | | | | | | | |
| | Activated | Composite | | | | | |
| | carbon 1 | 7 | 8 | 9 | 10 | 11 | 12 |
| Total specific | 2000 | 2020 | 2050 | 57 | 115 | 1620 | 85 |
| surface area (m²/g) | | | | | | | |
| Total pore volume | 1.171 | 1.005 | 1.201 | — | — | 0.689 | — |
| (cm³/g) | | | | | | | |
| (diameter = 0.5 | | | | | | | |
| to 100 nm) | | | | | | | |
| Pore volume (cm³/g) | 0.082 | 0.146 | 0.139 | Unable | Unable | 0.042 | Unable |
| (diameter = at least | | | | to | to | | to |
| 2.0 nm and | | | | measure | measure | | measure |
| less than 20.0 nm) | | | | | | | |
| Pore volume | 7 | 15 | 14 | — | — | 9 | — |
| proportion (%) | | | | | | | |
| (diameter = at least | | | | | | | |
| 2.0 nm and | | | | | | | |
| less than 20.0 nm) | | | | | | | |
| Pore volume (cm³/g) | 1.019 | 0.627 | 0.816 | — | — | 0.392 | — |
| (diameter = at least | | | | | | | |
| 0.5 nm and | | | | | | | |
| less than 2.0 nm) | | | | | | | |
| Pore volume proportion (%) | 87 | 63 | 62 | — | — | 57 | — |
| (diameter = at least | | | | | | | |
| 0.5 nm and | | | | | | | |
| less than 2.0 nm) | | | | | | | |

### <Production of Electrode for Evaluation: Working Examples 1-1 to 1-8, and Comparative Examples 1-1 to 1-5>

The aforementioned composites 1 to 12, the aforementioned activated carbon 1, a conductivity aid (acetylene black), and a binding agent (carboxymethyl cellulose) were mixed and dispersed at the composition ratios listed below in Table 2. Thereafter, water was gradually added, and the mixture was further blended to produce a paste-like material.

This paste was coated on aluminum collector electrode foil (30 μm thick) to result in 60 μm thickness. Thereafter, the assembly was dried for 24 h at 150° C. After compression treatment of the sheet-like electrodes at 20 MPa, disk-like samples were cut out (1 cm diameter) to produce evaluation electrodes A to M.

TABLE 2

| | Working Examples | | | | | | | |
|---|---|---|---|---|---|---|---|---|
| | 1-1 | 1-2 | 1-3 | 1-4 | 1-5 | 1-6 | 1-7 | 1-8 |
| Composite 1 | 90 | | | | | | | |
| Composite 2 | | 90 | | | | | | |
| Composite 3 | | | 90 | | | | | |
| Composite 4 | | | | 90 | | | | |
| Composite 5 | | | | | 90 | | | |
| Composite 6 | | | | | | 90 | | |
| Composite 7 | | | | | | | 90 | |
| Composite 8 | | | | | | | | 90 |
| Conductivity aid | 5 | 5 | 5 | 5 | 5 | 5 | 5 | 5 |
| Binding agent | 5 | 5 | 5 | 5 | 5 | 5 | 5 | 5 |
| Designation of evaluation | A | B | C | D | E | F | G | H |
| electrode | | | | | | | | |

| | Comparative Example | | | | |
|---|---|---|---|---|---|
| | 1-1 | 1-2 | 1-3 | 1-4 | 1-5 |
| Activated carbon 1 (NK 260) | 90 | | | | |
| Composite 9 | | 90 | | | |
| Composite 10 | | | 90 | | |
| Composite 11 | | | | 90 | |
| Composite 12 | | | | | 90 |
| Conductivity aid | 5 | 5 | 5 | 5 | 5 |
| Binding agent | 5 | 5 | 5 | 5 | 5 |
| Designation of | I | J | K | L | M |
| evaluation electrode | | | | | |

### <Electric Double-Layer Capacitor: Working Examples 2-1 to 2-6, Comparative Examples 2-1 to 2-4>

In Working Examples 2-1, 2-2, 2-3, 2-5, and 2-6, the evaluation electrodes A, B, C, E, and F, respectively, (made from the composites 1, 2, 3, 5, and 6, respectively) were used as positive electrodes. Evaluation electrodes I made from activated carbon 1 were used as the negative electrodes.

In Working Example 2-4, the evaluation electrode I made from activated carbon 1 was used as the positive electrode, and the evaluation electrode D made from the composite 4 was used as the negative electrode.

In Comparative Example 1, evaluation electrodes I made from activated carbon 1 were used as both the positive and negative electrodes.

In Comparative Examples 2-2, 2-3, and 2-4, evaluation electrodes J, K, and L, respectively, (made from composites 9, 10, and 11, respectively) were used as the positive electrodes. Evaluation electrodes I made from the activated carbon 1 were used as the negative electrodes.

An electric double-layer capacitor was produced using positive and negative electrodes separated by a separator formed from glass fiber (manufactured by Nippon Sheet Glass Co., Ltd.) and using a 1 mol/L tetraethyl ammonium tetrafluoroborate in propylene carbonate solution as the electrolyte solution.

### <Lithium Ion Capacitor: Working Examples 3-1 to 3-5, Comparative Examples 3-1 to 3-4>

### (Positive Electrode Material)

In Working Examples 3-1 to 3-5, the evaluation electrodes A, B, E, G, and H, respectively, (produced from the composites 1, 2, 5, 7, and 8, respectively) were used as positive electrodes.

In Comparative Examples 3-1 to 3-4 in the same manner, the evaluation electrodes I, J, K, and M, respectively, (made from activated carbon 1 and composites 9, 10, and 12, respectively) were used as positive electrodes.

### (Negative Electrode Material)

100 parts by mass of graphite (average particle diameter=30 μm, specific surface area=5 m²/g), 10 parts by mass of a 2 mass % concentration solution of polyvinylidene fluoride (average molecular weight=534,000, produced by Sigma-Aldrich Co., LLC.) in NMP, and 10 parts by mass of Ketjen black (average particle diameter=40 μm, specific surface area=800 m²/g) were mixed. The mixture was then stirred for 5 h, and then was heated at 150° C. to produce a slurry used for the negative electrode.

Thereafter, the aforementioned negative electrode slurry was coated on both faces of a negative collector formed from 30 μm thick (55% porosity) copper-based expanded metal to provide a negative electrode layer.

Thereafter, vacuum drying was used to produce a negative electrode that had a total thickness of 80 μm.

### (Production of Lithium Ion Capacitor)

Positive electrodes and negative electrodes produced from respective produced electrode materials were stacked with separators disposed between the electrodes, and the respective assemblies were dried in vacuum for 12 h at 150° C.

Thereafter, a single separator was placed on the outside, and the 4 sides were hermetically sealed to produce a lithium ion capacitor element.

Thereafter, metallic lithium to provide 350 mAh/g ion concentration doping relative to the mass amount of negative electrode active material was pressure bonded to 70 μm thick copper mesh, and 1 sheet of this material was placed at the outermost part of the aforementioned lithium ion capacitor element so as to oppose the negative electrode.

After insertion of the lithium ion capacitor element, into which metallic lithium had been placed in this manner, in an exterior covering laminate film, the assembly was impregnated under vacuum conditions using an electrolyte solution containing 1.2M LiPF₆ dissolved in propylene carbonate.

Thereafter, the exterior covering laminate film was heat sealed under vacuum conditions to assemble the lithium ion capacitor cell.

### <Electrostatic Capacitance>

Electrostatic capacitance and the cycle characteristics thereof were evaluated by the below-described methods for the produced electric double-layer capacitors and lithium ion capacitors. These results are shown below in Tables 3 and 4.

### (Electric Double-Layer Capacitor)

These electric double-layer capacitors were subjected to charging/discharging testing using a charging/discharging tester (made by Hokuto Denko Corp., HJ1001SM8A). The charging was performed at 60° C. by a constant current of 2 mA. After the voltage reached 3.0 V, the charging was performed by constant voltage charging for 1 hour. The discharging was performed at 60° C. by a constant current of 2 mA and with an end voltage of 0 V.

Charging/discharging testing was repeated 5,000 times for each capacitor, and the specific capacitance (electrostatic capacitance) was found per weight of electrode active material from the discharge curve of the 10-th cycle.

Furthermore, the specific capacitance per weight of the electrode active material was found from the discharge curve of the 5,000-th cycle and the ratio with the specific capacitance found from the discharge curve of the 10-th cycle was used as the cycle characteristics (i.e. specific capacitance found from 5,000-th cycle discharge curve/specific capacitance found from discharge curve of the 10-th cycle). This was used as a cycle characteristics indicator.

### (Lithium Ion Capacitor)

The produced lithium ion capacitor cell was charged by 20 C constant electrical current until the cell voltage reached 3.8V. Thereafter, 3.8V constant voltage was applied for 1 h to perform constant current-constant voltage charging.

Thereafter, using 20C constant electrical current, the cell was discharged until the cell voltage reached 2.2V.

Thereafter, continuous charging testing was performed for 1,000 h under 3.8V cell voltage and 60° C. conditions. The application of voltage was stopped after 1,000 h had elapsed, and the lithium ion capacitor cell was left for 10 h at 25° C. Thereafter, a 3.8V-2.2V charge-discharge cycle was performed, and the electrostatic capacitance (positive electrode electrostatic capacitance) was calculated. The electrostatic capacitance per positive electrode material in the 1st discharge was taken to be the initial electrostatic capacitance (i.e. electrostatic capacitance per unit weight of the positive electrode), and the electrostatic capacitance maintenance factor was determined versus the initial electrostatic capacitance. Testing was performed using a charging-discharging tester (HJ1001SM8A, manufactured by Hokuto Denko Corp.).

Here, the positive electrostatic capacitance is taken to indicate the slope of the discharge curve of the positive electrode in F units. The electrostatic capacitance per unit weight of the positive electrode (F/g units) is taken to be the value of the positive electrostatic capacitance divided by the weight of the positive electrode active material loaded into the cell.

TABLE 3
(electric double-layer capacitor)

| | Working Examples | | | | | | Comparative Example | | | |
|---|---|---|---|---|---|---|---|---|---|---|
| | 2-1 | 2-2 | 2-3 | 2-4 | 2-5 | 2-6 | 2-1 | 2-2 | 2-3 | 2-4 |
| Positive electrode | A | B | C | I | E | F | I | J | K | L |
| Negative electrode | I | I | I | D | I | I | I | I | I | I |
| Electrostatic | 33.4 | 37.2 | 35.1 | 35.9 | 40.1 | 36.6 | 26.1 | 24.5 | 22.1 | 25.7 |
| capacitance (F/g) | | | | | | | | | | |
| Cycle characteristics | 91% | 89% | 88% | 90% | 95% | 92% | 41% | 71% | 77% | 83% |
| (capacitance | | | | | | | | | | |
| maintenance factor) | | | | | | | | | | |

TABLE 4
(lithium ion capacitor)

| | Working Examples | | | | | Comparative Example | | | |
|---|---|---|---|---|---|---|---|---|---|
| | 3-1 | 3-2 | 3-3 | 3-4 | 3-5 | 3-1 | 3-2 | 3-3 | 3-4 |
| Positive | A | B | E | G | H | I | J | K | M |
| electrode | | | | | | | | | |
| Negative | Graphite material | | | | | | | | |
| electrode | | | | | | | | | |
| Electro- | 66.8 | 74.4 | 85.0 | 76.4 | 70.2 | 42.8 | 39.0 | 46.2 | 48.2 |
| static | | | | | | | | | |
| capac- | | | | | | | | | |
| itance | | | | | | | | | |
| (F/g) | | | | | | | | | |
| Cycle | 98% | 98% | 99% | 99% | 99% | 90% | 86% | 72% | 88% |
| charac- | | | | | | | | | |
| teristics | | | | | | | | | |
| (capac- | | | | | | | | | |
| itance | | | | | | | | | |
| mainte- | | | | | | | | | |
| nance | | | | | | | | | |
| factor) | | | | | | | | | |

Based on the aforementioned results shown in Table 3, when the composites 9 to 11 were used, which had pore volume proportions less than 10% for pores having diameters of greater than or equal to 2.0 nm and less than 20.0 nm, and had total pore volumes in the range of 0.3 to 3.0 cm³/g, electrostatic capacitance decreased to values lower than that of Comparative Example 2-1, which used non-composite activated carbon, and cycle characteristics were found to be inferior (Comparative Examples 2-2 to 2-4).

In contrast, when composites 1 to 6 were used, which had pore volume proportions greater than or equal to 10% for pores having diameters of greater than or equal to 2.0 nm and less than 20.0 nm, and had total pore volumes in the range of 0.3 to 3.0 cm³/g, electrostatic capacitance was higher than that of Comparative Example 1, and cycle characteristics were found to be excellent (Examples 2-1 to 2-6).

Based on these results, as described above, it may be surmised that the certain diameter pores of 2 to 20 nm diameter are useful as sites that are capable of diffusion and adsorption of solvated ions.

In particular, from a comparison between Example 2-2 and Example 2-5, it is understood that dedoping by heat treatment is extremely effective even when the same dispersion is used.

Based on the aforementioned results shown in Table 4, when the composites, 9, 10, and 12 were used, which had pore volume proportions less than 10% for pores having diameters of greater than or equal to 2.0 nm and less than 20.0 nm, electrostatic capacitance decreased to values lower than that of Comparative Example 3-1, which used non-composite activated carbon, and cycle characteristics (electrostatic capacitance maintenance factor) were found to be inferior even if electrostatic capacitance increased (Comparative Examples 3-2 to 3-4).

In contrast, when composites 1, 2, 5, 7, and 8 were used, which had total pore volumes in the range of 0.3 to 3.0 cm³/g and had pore volume proportions greater than or equal to 10% for pores having diameters of greater than or equal to 2.0 nm and less than 20.0 nm, electrostatic capacitance was higher than that of Comparative Example 3-1, and cycle characteristics were found to be excellent (Working Examples 3-1 to 3-5).

Based on these results, as described above, it may be surmised that the certain diameter pores of 2 to 20 nm diameter are useful as sites that are capable of diffusion and adsorption of solvated ions.

In particular, from a comparison between Working Example 3-2 and Working Example 3-3, it is understood that dedoping by heat treatment is extremely effective even when the same dispersion is used.

1. A composite of a porous carbon material and a conductive polymer having nitrogen atoms; wherein
the conductive polymer is bound to a surface of the porous carbon material;
a total pore volume of all of the pores having a diameter of 0.5 to 100.0 nm measured by a BJH method is from 0.3 to 3.0 cm³/g; and
a proportion, measured by the BJH method, of the pore volume of the pores having a diameter of greater than or equal to 2.0 nm and less than 20.0 nm is greater than or equal to 10% of the total pore volume.

2. The composite according to claim 1; wherein a proportion, measured by the BJH method, of the pore volume of pores having a diameter of greater than or equal to 0.5 nm and less than 2.0 nm is less than 70% of the total pore volume.

3. The composite according to claim 1; wherein a total specific surface area is from 1,300 to 2,500 m²/g.

4. The composite according to claim 1; wherein the conductive polymer is at least one selected from the group consisting of polyaniline, polypyrrole, polypyridine, polyquinoline, polythiazole, polyquinoxaline, and derivatives thereof.

5. The composite according to claim 1; wherein the porous carbon material is activated carbon and/or graphite.

6. An electrode material comprising the composite described in claim 1.

7. An electric double-layer capacitor comprising a polarizable electrode using the electrode material described in claim 6.

8. A lithium ion secondary battery having a negative electrode comprising the electrode material described in claim 6.

9. A lithium ion capacitor having a positive electrode and/or a negative electrode comprising the electrode material described in claim 6.

10. The composite according to claim 2; wherein a total specific surface area is from 1,300 to 2,500 m²/g.

11. The composite according to claim 2; wherein the conductive polymer is at least one selected from the group consisting of polyaniline, polypyrrole, polypyridine, polyquinoline, polythiazole, polyquinoxaline, and derivatives thereof.

12. The composite according to claim 3; wherein the conductive polymer is at least one selected from the group consisting of polyaniline, polypyrrole, polypyridine, polyquinoline, polythiazole, polyquinoxaline, and derivatives thereof.

13. The composite according to claim 2; wherein the porous carbon material is activated carbon and/or graphite.

14. The composite according to claim 3; wherein the porous carbon material is activated carbon and/or graphite.

15. The composite according to claim 4; wherein the porous carbon material is activated carbon and/or graphite.

16. An electrode material comprising the composite described in claim 2.

17. An electrode material comprising the composite described in claim 3.

18. An electrode material comprising the composite described in claim 4.

19. An electrode material comprising the composite described in claim 5.
